(19) United States
(12) Patent Application Publication
(10) Pub. No.: US 2003/0151595 A1
(43) Pub. Date: Aug. 14, 2003

(54) System and method for detecting unhealthy operation posture of using keyboard

(76) Inventors: Min-Shan Chuang, Taoyuan City (TW); Mao-Sung Huang, Taoyuan City (TW)

Correspondence Address: Cynthia L. Pillote, Snell & Wilmer L.L.P., One Arizona Center, 400 East Van Buren, Phoenix, AZ, 85004-2202, US

(21) Appl. No.: 10/360,708

(22) Filed: Feb. 6, 2003

(30) Foreign Application Priority Data
Feb. 8, 2002 (TW) 091102542

(51) Int. Cl. G09G 5/00

(52) U.S. Cl. 345/168

(57) ABSTRACT

The present invention relates to a detection system and a method for detecting unhealthy postures of using the keyboard. The detection system includes a keyboard, a triggering element, and a processor. The keyboard includes a palm rest. The triggering element is coupled to the palm rest and includes at least one circuit. The processor electrically connects to the circuit. When the triggering element is depressed, the circuit transmits a signal to the processor. The processor processes the signal and sends out a corresponding warning signal.

### CROSS REFERENCE TO RELATED APPLICATIONS

This Application claims priority to Taiwan Patent Application No. 091102542 entitled “System and Method for Detecting Unhealthy Operation Posture while Using Keyboard”, filed Feb. 8, 2002.

### FIELD OF THE INVENTION

The present invention relates to a detection system and a method for detecting unhealthy postures of using keyboard.

### BACKGROUND OF THE INVENTION

Modern life is closely linked to computers. Many people use the computer everyday. The illness caused by using the computer is getting more serious than ever.

Unhealthy long-term postures of using the computer peripherals lead to parts of the health problems. Among them, most common problems are caused by using keyboards. It does harm to the user's wrists if the posture of wrists is not correct. The user is usually not conscious of the incorrect injury posture until the injury takes place.

Besides, using the keyboard for a long time between rests is also an important cause of the problems. Operating the keyboard for a long time often causes injury extending from the shoulder to the wrist. However, this kind of injury also often happens without the user's awareness.

There are many keyboards on market with special design to protect wrists. A palm rest is added to the end terminal of this kind of keyboard to provide support for the wrist. Correct usage of this kind of keyboard may reduce likeliness of wrist injuries. However, it is still possible to do harm to wrists if the posture is unhealthy.

On the whole, most health problems caused by operating the computer peripherals including the unhealthy posture and long-term operation occur when the user is unaware. To solve the problem, the present invention provides a detection system and a method for warning the user of unhealthy postures.

### SUMMARY OF THE INVENTION

An aspect of the present invention is providing a detection system and a method for detecting unhealthy operation postures of using the keyboard.

Another aspect of the present invention is providing a detection system and a method for making a timely warning to the user to protect his (her) wrist.

Still another aspect of the present invention is providing a detection system and a method for detecting the operation state and operation time to remind the user to take a rest in time.

The detection system of the present invention includes a keyboard, a triggering element and a processor. The keyboard has a palm rest, to which the triggering element is connected. The processor is electrically connected with the triggering element. When the triggering element is pressed, it transmits a signal to the processor. The processor processes the signal and sends out a corresponding warning signal.

Moreover, the present invention provides a method implemented in the detection system. First, the triggering element and the keyboard respectively transmit a first signal and a second signal at a time t. Next, the first state of the triggering element and the second state of the keyboard are determined respectively by the first and second signals. By means of the first state of the triggering element and the second state of the keyboard, the user state and a duration of the user state are determined. At last, a corresponding warning signal is sent out according to the user state and the duration.

### BRIEF DESCRIPTION OF THE DRAWINGS

FIG. 1 a top view of the exemplary embodiment of the present invention,

FIG. 2 a side view of the exemplary embodiment shown in FIG. 1; and

FIG. 3 a flow chart of the method implemented in the processor of the present invention.

### DETAILED DESCRIPTION OF THE INVENTION

The present invention provides a detection system and a method for detecting unhealthy operation postures of using the keyboard. The detecting system makes a timely warning to the user to protect his (her) wrist. However, the present invention is not restricted to the implementation mentioned hereinafter. For example, the present invention also detects the operation state and operation time to remind the user to take a rest in good time.

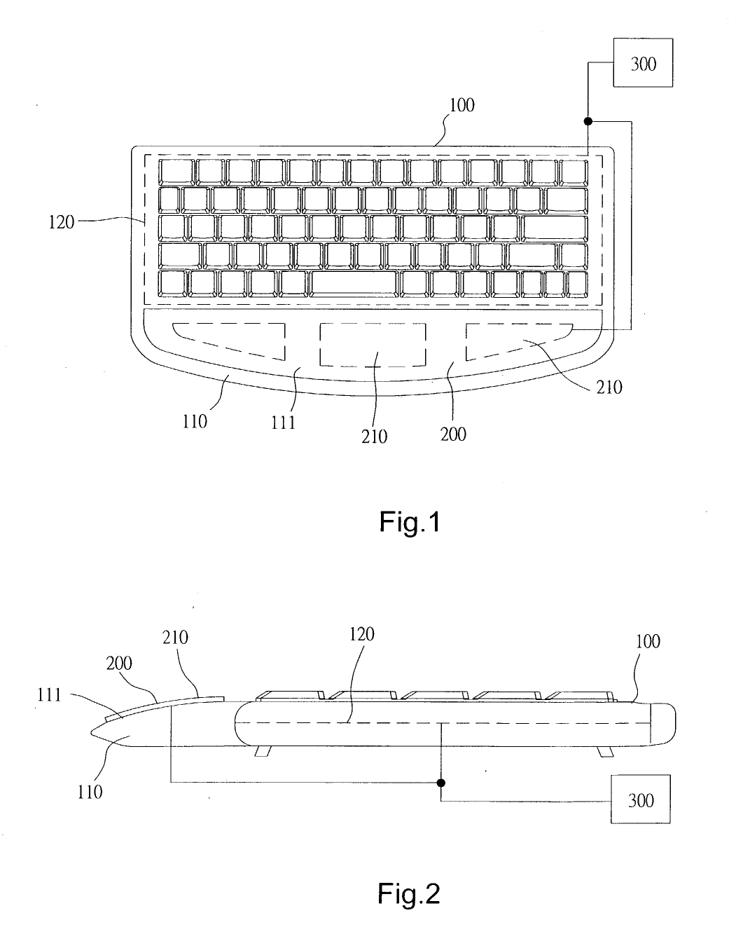

Referring to FIG. 1, a top view shows one embodiment of the present invention. The detection system of the present invention includes a keyboard 100, a triggering element 200 and a processor 300. The keyboard 100 has a palm rest 110. The palm rest 10 selectively connects separably or inseparably to the keyboard 100. The palm rest 110 is formed by various materials, such as, resin, plastic, rubber, metal, etc.

FIG. 2 is a side view of the embodiment shown in FIG. 1. As shown in FIG. 2, the triggering element 200 connects to the palm rest 10. In this embodiment, the triggering element 200 is formed with a membrane circuit 210. Yet in another embodiment, the triggering element 200 is formed with a circuit device. The processor 300 connects electrically to the triggering element 200. When the triggering element 200 receives a pressure, the triggering element 200 sends out a signal to the processor 300. The processor 300 processes the signal and sends out a corresponding warning signal based on a predetermined configuration.

In the preferred embodiment shown in FIG. 2, the triggering element 200 is disposed on an upper surface 111 of the palm rest 110. In another embodiment, however, the triggering element 200 can also be disposed on the lower surface or the inner part of the palm rest 110.

Referring now back to FIGS. 1 and 2, the keyboard 100 further includes a keyboard circuit 120 electrically connected to the processor 300. In this embodiment, the triggering element 200 connects electrically to the processor 300 through the keyboard circuit 120. However, in another embodiment, the triggering element 200 and the keyboard circuit 120 connect electrically to the processor 300 respectively.

In the embodiment, the processor 300 is a desktop computer, portable computer, personal digital assistant, or mobile phone, etc. The warning signal sent out from the processor 300 is a sound, display information on a screen, or vibration, etc.

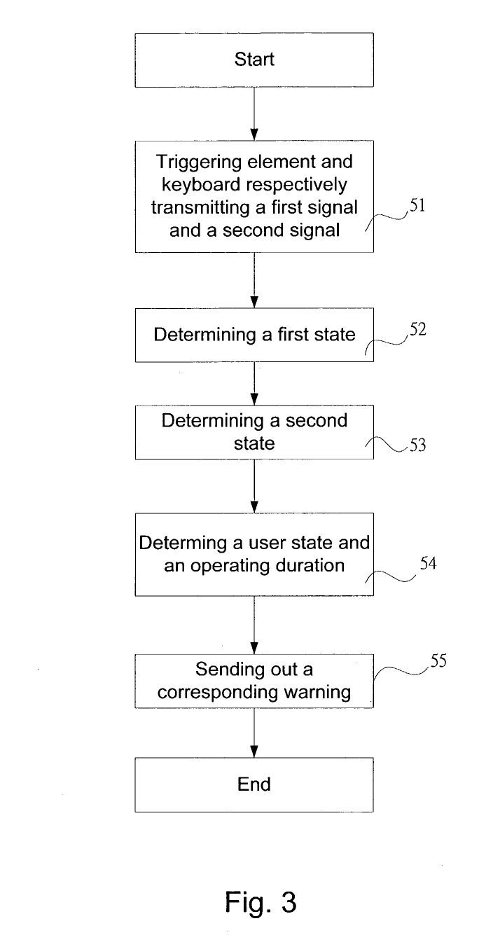

FIG. 3 is a flowchart of the method implemented in the processor 300. In step 51, the triggering element 200 and the keyboard 100 respectively transmit a first signal and a second signal at a time t. In the embodiment, a first signal transmitted by triggering element 200 is based on whether the triggering element 200 is depressed. When the triggering element 200 is depressed, it transmits the first signal indicating the state of the depression. Or when the triggering element 200 is not depressed, it selectively transmits a first signal or nothing to indicate or represent the state of non-depression. However, the first signal can be defined as still another state of the triggering element 200, e.g., the depressed position of the triggering element 200. A second signal transmitted by keyboard 100 is based on whether the keyboard 100 is operated. When the keyboard 100 is operated, it transmits the second signal indicating the state of the operation. When the keyboard 100 is not operated, it selectively transmits a second signal or nothing to indicate or represent the state of non-operation.

In step 52, the first state of the triggering element 200 at a time t is determined based on the first signal sent out from the triggering element 200. In this embodiment, the first state of the triggering element 200 at a time t is defined as a depression state when the triggering element 200 is depressed at the time t and transmits a first signal indicating the state to represent the depression. Comparatively, the first state of the triggering element 200 at a time t is defined as a non-depression state when the triggering element 200 is not depressed at the time t and transmits a first signal or nothing to indicate or present the non-depression state.

In step 53, the second state of the keyboard 100 at a time t is determined based on the second signal sent out from the keyboard 100. In this embodiment, the second state of the keyboard 100 at a time t is defined as an operation state when the keyboard 100 is operated at the time t and transmits a second signal indicating the state to represent the operation. Comparatively, the second state of the keyboard 100 at a time t is defined as a non-operation state when the keyboard 100 is not operated at the time t and transmits a second signal or nothing to indicate or present the non-operation state.

In step 54, the user state and the operating duration of the user state are determined based on the first and the second states at the time t. In the embodiment described above, the user state is determined as an unhealthy operation posture when the first state is a depression state and the second state is an operation state. The user state is determined as a healthy operation posture when the first state is not a depression state and the second state is an operation state. The user state is determined as a rest state when the first state is a depression state and the second state is not an operation state.

In step 55, a corresponding warning signal is sent out based on the user state and the operating duration. In the embodiment described above, a warning signal is sent out when the user state is an unhealthy operation posture and the operating duration reaches a pre-set time interval. A corresponding warning signal is sent out continuously when the operating duration is even extended. In another embodiment, the time interval set in the healthy operation posture state is longer than the time interval set in the unhealthy operation. The warning signal is capable of reminding the user to take a rest and is sent out as a sound, display information on a screen, or vibration, etc. The warning signal can include not only the essential element of giving the user a notice but other information such as warning types, or accumulative operation time, etc.

In the foregoing specification the invention has been described with reference to specific exemplary aspects thereof It will, however, be evident that various modification and changes may be made thereto without departing from the broader spirit and scope of the invention. The specification and drawings are, accordingly, to be regarded in an illustrative rather than restrictive sense.

We claim:

1. A detection system for making a warning when detecting unhealthy operation posture while using a keyboard, comprising:
a keyboard having a palm rest;
a triggering element connected with said palm rest; and
a processor electrically connected with said triggering element;
wherein, when said triggering element is pressed, said triggering element transmits a signal to said processor, and said processor sends out a warning signal at a predetermined time.

2. The detection system according to claim 1, wherein said triggering element is disposed on an upper surface of said palm rest.

3. The detection system according to claim 1, wherein said keyboard comprises a keyboard circuit electrically connected with said processor.

4. The detection system according to claim 3, wherein said triggering element is electrically connected with said processor through said keyboard circuit.

5. The detection system according to claim 1, wherein said triggering element is formed with a membrane circuit.

6. The detection system according to claim 1, wherein said triggering element is formed with a circuit device.

7. The detection system according to claim 1, wherein said processor is a desktop personal computer.

8. The detection system according to claim 1, wherein said processor is a portable computer.

9. The detection system according to claim 1, wherein said warning signal is a sound.

10. The detection system according to claim 1, wherein said warning signal is a display information on a screen.

11. A method implemented in the processor of the detection system of claim 1 comprising:
(1) at a time t, the triggering element and the keyboard transmitting a first signal and a second signal respectively;
(2) determining a first state of said triggering element based on said first signal;
(3) determining a second state of said keyboard based on said second signal;
(4) determining a user state at said time t and a operating duration of said user state based on said first state and said second state;
(5) sending out a corresponding warning signal based on said user state and said operating duration.

12. The method according to claim 11, as said first state is a depressed state and said second state is an operation state, the method determines said user state is an unhealthy operation posture.

13. The method according to claim 11, as said first state is not a depressed state and said second state is an operation state, the method determines said user state is a healthy operation posture.

14. The method according to claim 11, as said first state is a depressed state and said second state is not an operation state, the method determines said user state is a rest state.
